(19) United States
(12) Patent Application Publication
(10) Pub. No.: US 2012/0111011 A1
(43) Pub. Date: May 10, 2012

(54) BYPASS TURBINE INTAKE

(75) Inventor: Anthony Richard Pike, Alton (GB)

(73) Assignee: General Electric Company, Schenectady, NY (US)

(21) Appl. No.: 12/943,675

(22) Filed: Nov. 10, 2010

(51) Int. Cl. F02C 1/00

(52) U.S. Cl. 60/722

(57) ABSTRACT

A system, that includes a bypass turbine intake configured to route a bypass supply of air to a turbine engine to bypass an air filter of a main turbine intake, wherein the bypass turbine intake comprises a louvered door having a plurality of louvers configured to move between a closed position and an open position, the open position enables flow of the bypass supply of air to the turbine engine, and the closed position disables flow of the bypass supply of air to the turbine engine.

### BACKGROUND OF THE INVENTION

The subject matter disclosed herein relates to gas turbine engines, and more particularly, a bypass turbine intake to deliver a bypass airflow to a gas turbine engine while a main turbine intake is malfunctioning.

A gas turbine engine combusts a fuel-air mixture to generate hot combustion gases, which drive rotation of turbine blades in a turbine section. The gas turbine engine may be used to drive an electrical generator, a propulsion system, or any other device. In large ships, the gas turbine engine may be used to drive both an electrical generator and a propulsion system. The gas turbine engine generally receives an airflow through a main turbine intake, which includes a filter to block particulate and moisture from reaching the internal components of the gas turbine engine. However, if the filter becomes clogged with debris, then the gas turbine engine is unable to function. Unfortunately, a non-functional gas turbine engine may result in loss of electrical power and/or propulsion, which may be unacceptable in certain situations.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a bypass turbine intake configured to route a bypass supply of air to a turbine engine to bypass an air filter of a main turbine intake, wherein the bypass turbine intake comprises a louvered door having a plurality of louvers configured to move between a closed position and an open position, the open position enables flow of the bypass supply of air to the turbine engine, and the closed position disables flow of the bypass supply of air to the turbine engine.

In a second embodiment, an apparatus includes a bypass engine intake configured to route a bypass supply of air to an engine to bypass an air filter of a main engine intake, wherein the bypass engine intake includes, a louvered door having a plurality of louvers, a drive having a louver actuator, and a controller configured to control the drive to move the plurality of louvers between a closed position and an open position in response to a condition of the main engine intake, the open position enables flow of the bypass supply of air to the engine, the closed position disables flow of the bypass supply of air to the engine, and the condition comprises a change in a main supply of air through the main air intake outside a threshold range.

In a third embodiment, a method includes sensing a condition of a main engine intake indicating a change in a main supply of air through the main air intake outside a threshold range, and controlling a louvered door to open a plurality of louvers to enable a bypass supply of air to flow through a bypass engine intake to an engine in response to the condition.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a sectional view of an embodiment of a ship that includes a gas turbine engine with a main turbine intake and a bypass turbine intake;

FIG. 2 is a flow chart of an embodiment of a process for controlling air intake into a gas turbine engine;

FIG. 3 is a schematic side view of an embodiment of a bypass turbine intake having a louvered door with a plurality of louvers in a closed position;

FIG. 4 is a schematic side view of an embodiment of a bypass turbine intake having a louvered door with a plurality of louvers in an open position;

FIG. 5 is a partial schematic side view of an embodiment of the louvered door taken within line 5-5 of FIG. 3, illustrating two louvers with a sealing interface;

FIG. 6 is a partial schematic side view of an embodiment of the louvered door taken within line 6-6 of FIG. 5, illustrating the sealing interface with a single seal between the two louvers;

FIG. 7 is a partial schematic side view of an embodiment of the louvered door taken within line 6-6 of FIG. 5, illustrating the sealing interface with two seals between the two louvers;

FIG. 8 is a partial schematic side view of an embodiment of the louvered door taken within line 6-6 of FIG. 5, illustrating the sealing interface with three seals along male and female portions between the two louvers;

FIG. 9 is a partial perspective end view of an embodiment of a louver with end seals;

FIG. 10 is a partial perspective end view of an embodiment of a louver with end seals;

FIG. 11 is a schematic side view of an embodiment of a bypass turbine intake having a louvered door with a plurality of louvers in an open position;

FIG. 12 is a perspective view of an embodiment of a bypass turbine intake having a louvered door with a plurality of louvers in an open position; and

FIG. 13 is an end view of an embodiment of a louver of the bypass turbine intake of FIG. 12, illustrating gasket material on opposite sides of the louver.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments are directed to a bypass turbine intake having a louvered door, which includes a plurality of louvers rotatable between open and closed positions. A gas turbine engine generally receives an airflow from a main turbine intake, which may include a filter. If the main turbine intake becomes non-functional (e.g., blockage of the filter), then the gas turbine engine can receive a bypass airflow from the bypass turbine intake. In other words, the bypass turbine intake is configured to bypass the main turbine intake (e.g., bypass the filter), and provide the bypass airflow to the gas turbine engine to ensure continued operation of the gas turbine engine. In certain embodiments, the bypass turbine intake does not include a filter, and thus provides unfiltered bypass air to the gas turbine engine in the event of blockage of the main turbine intake. As discussed in detail below, the louvered door of the bypass turbine intake is configured to improve performance as compared with a single large door. For example, as discussed below, the louvered door reduces space consumption to open and close the bypass airflow through the bypass turbine intake, reduces the possibility of allowing loose objects into the bypass airflow, improves the response time, and decreases the power to open and close the bypass turbine intake. While not open, the bypass turbine intake remains sealed to ensure that the air is filtered through the filter of the main turbine intake. In certain embodiments, the louvered door of the bypass turbine intake includes one or more seals on opposite faces and opposite ends of each louver, thereby providing an airtight seal across the entire bypass turbine intake. The louvered door of the bypass turbine intake may be coupled to a variety of drives, such as an electric, pneumatic, or hydraulic drive. The drive also may be coupled to a controller, which receives feedback indicative of a blockage or failure of the main turbine intake. Although the bypass turbine intake may be used in a variety of turbine based systems, the following discussion is presented in context of watercraft (e.g., a ship) having the gas turbine engine, the main turbine intake, and the bypass turbine intake.

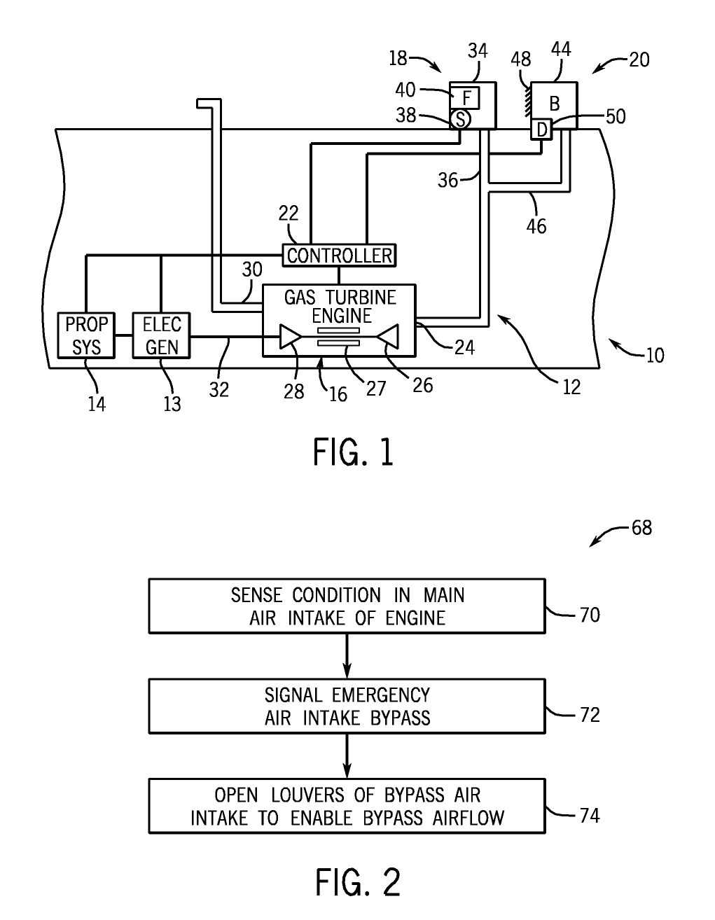

FIG. 1 is a sectional view of an embodiment of a ship 10 that includes a gas turbine system 12, which drives an electrical generator 13 and a propulsion system 14. The turbine system 12 includes a gas turbine engine 16, a primary intake section 18 (e.g., main turbine intake), a secondary intake section 20 (e.g., a bypass turbine intake), and a controller 22. The controller 22 is configured to control operation of the gas turbine engine 16, the intake sections 18 and 20, the generator 13, and/or the propulsion system 14. In certain embodiments, the controller 22 may be configured to actuate the secondary intake section 20 upon receiving feedback indicative of a blockage, failure, or problem with the primary intake section 18. For example, if the controller 22 receives feedback of a sudden change in pressure in the primary intake section 18, then the controller 22 may open the secondary intake section 20 to ensure sufficient airflow to the turbine engine 16. As discussed in detail below, the secondary intake section 20 includes a louvered door 48 to improve performance and reduce space consumption, while maintaining a seal across the secondary intake section 20 during normal operation of the primary intake section 18.

The turbine engine 16 includes an air intake 24, a compressor 26, a combustor 27, a turbine 28, and an exhaust 30. The compressor 26 may include one or more compressor stages, each having a plurality of compressor blades rotatable by a shaft. For example, the compressor 26 may be driven by a shaft coupled to the turbine 28. The compressor 26 is receives an airflow either through the air intake 24, either from the primary intake section 18 or the secondary intake section 20. During normal operation, the primary intake section 18 supplies the entire airflow to the compressor 26, while the secondary intake section 18 is sealed by the louvered door 48. However, if the primary intake section 18 is blocked, damaged, or generally fails to provide sufficient airflow to the turbine engine 16, then the secondary intake section 18 opens the louvered door 48 to supply a bypass airflow to the turbine engine 16. Regardless of the source of airflow, the compressor 26 receives, compresses, and directs compressed air to the combustor 27, which then mixes the compressed air with fuel and combusts the mixture to produce hot combustion gases. The turbine 28 then receives the hot combustion gases, which drive one or more turbine stages, each having a plurality of turbine blades coupled to a shaft. For example, the turbine system 12 may include one or more shafts 32, which couple the compressor 26, the turbine 28, the generator 13, and the propulsion system 14. Eventually, the hot combustion gases exit the turbine engine 16 through the exhaust 30.

The air for combustion in the turbine engine 16 normally comes from the primary intake section 18. The primary intake section 18 includes a housing 34, primary piping 36, and one or more sensors 38. The housing 34 houses one or more filters 40 configured to filter the airflow of any particulate and moisture, thereby protecting the turbine engine 16 from potential damage by the particulate or moisture. The filters 40 may be any kind of filter suitable for filtering the air of particulates and moisture. The primary piping 36 is configured to route the main supply of air passing through the filters 40 to the turbine engine 16. The sensor 38 is configured to monitor operation of the primary intake section 18, e.g., pressure, flow rate, flow velocity, or any combination. In particular, the feedback provided by the sensor 38 to the controller 22 is configured to enable the controller 22 to identify a potential blockage, malfunction, or other problem associated with the primary intake section 18. For example, the sensor 42 may monitor a pressure differential that indicates whether the filter 40 is blocked or obstructed by debris. In a different embodiment, the sensor 42 may be a flow rate sensor that monitors the amount of air passing through the filter to determine whether sufficient amounts of air are reaching the turbine engine 16. The controller 22 continually monitors the information received by sensor 38 as a trigger event for actuation of the secondary intake section 20.

In the event of a problem with the primary intake section 18, the controller 22 may signal the activation of the secondary intake section 20, e.g., open the louvered door 48. The secondary intake section 20 may include a housing 44, a secondary piping 46, the louvered door 48, and a drive 50. In the illustrated embodiment, the secondary intake section 20 excludes a filter in contrast to the primary intake section 18. Thus, the housing 44 of the secondary intake section 20 may be significantly smaller than the housing 34 of the primary intake section 18. Furthermore, as discussed below, the louvered door 48 is configured to reduce space consumption relative to a single large door, while also improving performance of the secondary intake section 20. During normal operation of the primary intake section 18, the secondary intake section 20 remains closed and sealed to prevent particulate or moisture from entering the turbine engine 16. However, when the controller 22 identifies a problem with the primary intake section 18, the controller 22 actuates the drive 50 of the secondary intake section 20 to open louvers of the louvered door 48. As the louvered door 48 opens, the bypass airflow passes to the secondary piping 46, which in turn leads to the air intake 24 of the turbine engine 16. In the illustrated embodiment, the primary and secondary piping 36 and 46 intersect upstream of the air intake 24. In other embodiments, the piping 36 and 46 may independently lead to the air intake 24. In either embodiment, the secondary piping 46 routes the bypass airflow to the turbine engine 16 without passing the bypass airflow through the filter 40.

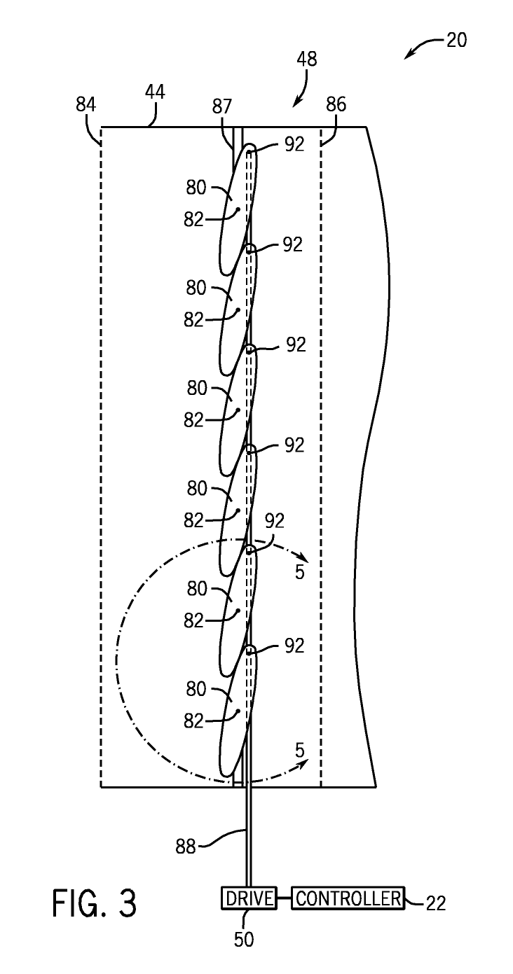

FIG. 2 is a flow chart of an embodiment of a process 68 for controlling air intake into the gas turbine engine 16. As briefly mentioned above, the primary intake section 18 may become obstructed or damaged during operation of the ship 10. Depending on the situation, the crew may follow several courses of action. For example, the crew may investigate the primary intake section 18 while leaving the system 12 in operation. The crew may shutdown the turbine engine 16 while investigating and servicing the primary intake section 18. Still, there may be some situations when the turbine engine 16 needs to remain in operation even though the primary intake section 18 is completely blocked or severely damaged. For example, a ship 10 serving in combat requires power for weapons systems, as well as, propulsion. If damage occurs to the primary intake section 18 during a critical time or emergency, then the turbine system 12 may employ the secondary intake section 20 to maintain airflow to ensure continued operation of the system 12.

In the illustrated embodiment, the process 68 may include sensing a condition in a main air intake of an engine (block 70). For example, the process 68 may receive and evaluate feedback from one or more sensors 38, and identify a potential blockage or damage to the primary intake section 18 of the turbine engine 16. The sensor feedback may include air pressure, airflow rate, air velocity, or any combination thereof. The sensor feedback also may include feedback indicative of a flame, smoke, water, ice, or debris in the primary intake section 18. The controller 22 analyzes the sensor feedback to determine whether there is a reduction in the main supply of air outside a threshold level. A reduction in the airflow to the turbine engine 16 may indicate that the primary intake section 18 is obstructed or has some other kind of problem. If the turbine engine 16 is unable to receive sufficient airflow to continue combustion and the ship is in the middle of an emergency (e.g., combat, collision course, etc.), then the process 68 may signal an emergency air intake bypass (block 72). For example, the controller 22 may provide an alarm to the crew, display an alarm message on a display, and/or send a control signal to the drive 50 of the secondary intake section 20. The process 68 may then open louvers of the bypass air intake to enable bypass airflow to the turbine engine 16 (block 74). For example, the signal from the controller 22 may trigger the drive 50 to open louvers of the louvered door 48, thereby enabling the bypass airflow to the turbine engine 16 despite blockage of the primary intake section 18.

FIG. 3 schematic side view of an embodiment of the secondary intake section 20 having the louvered door 48 with a plurality of sealable louvers 80 in a closed position, wherein the louvers 80 are rotated about their respective axes 82 to completely seal the secondary intake section 20. In the illustrated embodiment, the louvered door 48 is disposed in the housing 44 between an upstream screen 84 and a downstream screen 86, which may be optionally included to prevent interference with the louvers 80. For example, the screens 84 and 86 may block large debris, crewman, or other substances from interfering with the louvers 80, while the secondary intake section 20 excludes any type of small particulate filter. The louvered door 48 also includes a rotational support 87, which may include rotational support structures on opposite sides of the louvers 80 to enable rotation about the axes 82 of the louvers 80. Furthermore, the louvered door 48 includes a drive rod 88 coupled to each louver 80 at a connection point 92, which may be a rotational coupling or pivot joint. The drive rod 88 coupled with the drive 50, which is controlled by the controller 22.

Together, the louvers 80 all rotate about their respective axes 82 in combination with one another, thereby providing simultaneous opening and closing of all of the louvers 80. As discussed below, the louvers 80 sealingly engage one another in the closed position, thereby providing an airtight seal across the secondary intake section 20. The sealing engagement between the louvers 80 prevents undesirable particulates and moisture from entering the turbine engine 16. Each louver 80 has a rotational axis 82, which includes a single shaft or opposite pins extending through opposite ends of the louver 80. Thus, each louver 80 is configured to rotate about the axis 82 to open and close the louver 80. The drive rod 88 is coupled to each louver 80 at the connection point 92, which is offset from the axis 82 of the louver 80. Thus, as the drive rod 88 moves linearly upward or downward, the drive rod 88 causes all of the louvers 80 to rotate about their respective axes 82. The drive rod 88 is driven by the drive 50, which may be an electrical, pneumatic, or hydraulic drive. In certain embodiments, the drive 50 may include a manual actuator, such as a lever, wheel, or the like, enabling a crewman to manually open or close the louvered door 48.

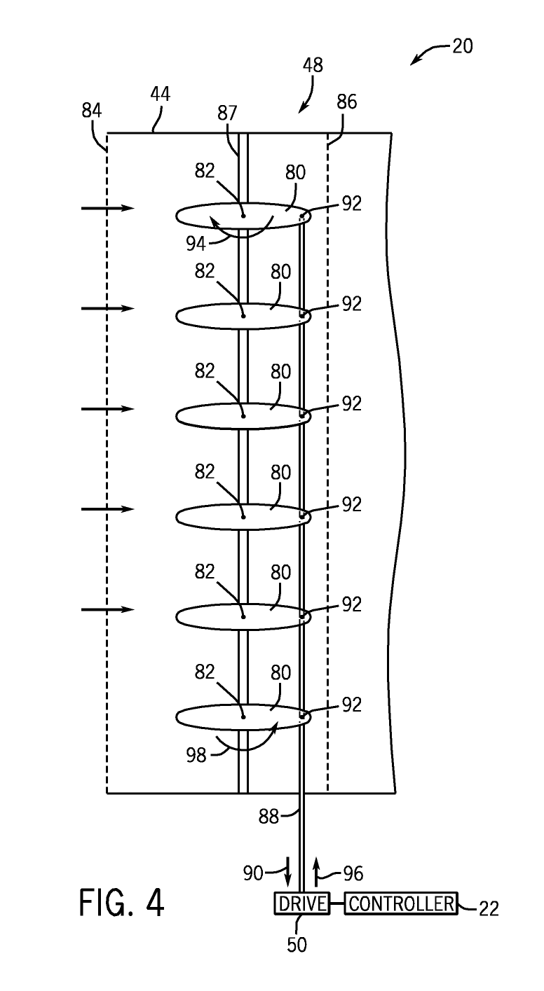

During normal operation, the louvered door 48 remains shut while the primary intake section 18 filters the air that enters the turbine engine 16. In emergencies involving blockage or malfunctioning of the primary intake section 18, the louvered door 48 opens allowing air to enter the secondary intake section 20. The louvered door 48 may also function as an anti-surge/stall device (i.e., the louvered door 48 may open to allow reverse flow created by the gas turbine 16 in an emergency). FIG. 4 is a schematic side view of an embodiment of the secondary intake section 20 having the louvered door 48 with the plurality of louvers 80 in an open position. As discussed above, the controller 22 opens and closes the louvered door 48 by sending a signal to the drive 50, which then moves the rod 88 in either a downward or an upward direction depending on whether the louvered door 48 needs to be opened or closed. When the controller 22 signals the drive 50 to open the louvered door 48, the drive 50 moves the rod 88 in a downward direction as indicated by arrow 90. As the rod 88 moves in the downward direction of arrow 90, the rod 88 pulls on the louvers 80 via connection points 92, thereby causing the louvers 80 to rotate in a clockwise direction about their axes 82 as indicated by arrow 94. Shutting the bypass door involves reversing the operation. If the controller 22 sends a signal to the drive 50 to close the louvered door 48, then the drive 50 moves the rod 88 in an upward direction as indicated by arrow 96. As the rod 88 moves in the upward direction of arrow 96, the rod 88 pushes on the louvers 80 via connection points 92, thereby causing the louvers 80 to rotate in a counterclockwise direction about their axes 82 as indicated by arrow 98. In other embodiments, the rotation of the louvers 80 may be reversed to provide opening and closing of the louvers 80. In particular, the rod 88 may cause the louvers 80 to rotate clockwise 94 to close and counterclockwise 98 to open.

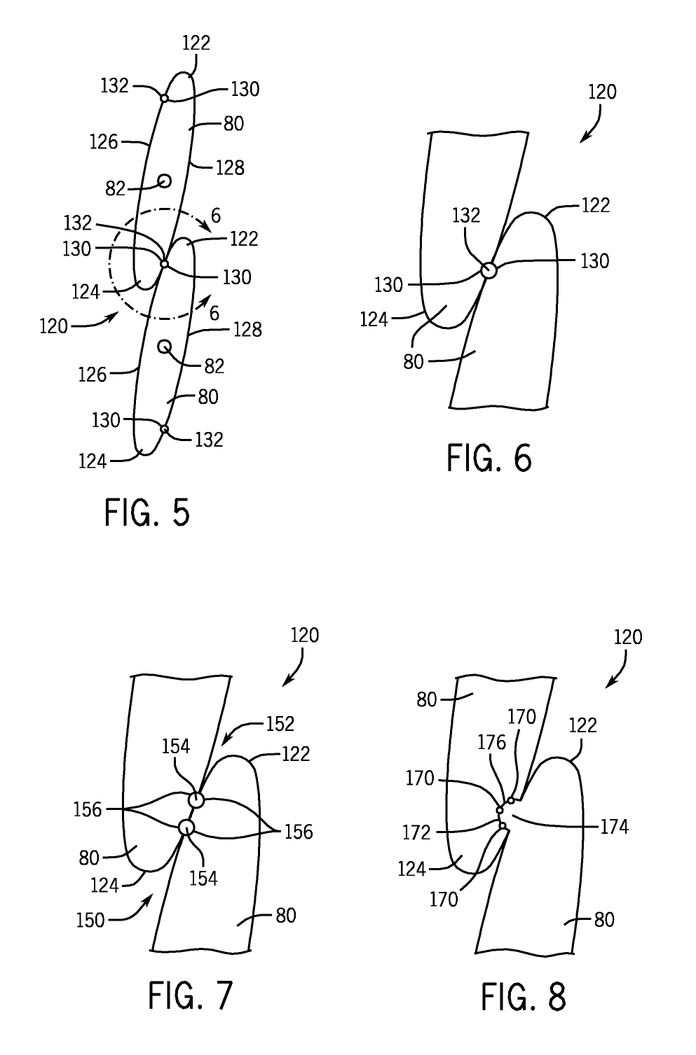

FIG. 5 is a partial schematic side view of an embodiment of the louvered door 48 taken within line 5-5 of FIG. 3, illustrating two louvers 80 with a sealing interface 120. Each of the louvers 80 defines a trailing edge 122, a leading edge 124, a front face 126, and a rear face 128. Furthermore, the louvers 80 define cavities 130 on the front face 126 near the trailing edge 122, and on the rear face 128 near the leading edge 124. Each pair of adjacent cavities 130 supports a seal or gasket 132 to define the sealing interface 120 between the louvers 80. The gasket 132 may be made of a fabric, a polymer, an elastomer, rubber, foam, silicone, cork, or a combination thereof. For example, the gasket 132 may be an elongated strip (e.g., a cylindrical strip, rectangular strip, or braided fibers) of one or more of these gasket materials extending along (and recessed into) the cavities 130.

FIG. 6 is a partial schematic side view of an embodiment of the louvered door 48 taken within line 6-6 of FIG. 5, illustrating the sealing interface 120 with the single gasket 132 between the two louvers 80. In the illustrated embodiment, each cavity 130 is a curved recess (e.g., a semi-circular recess), which extends lengthwise along the louvers 80 generally parallel to the trailing and leading edges 122 and 124. Thus, the gasket 132 (e.g., a round, circular, or cylindrical strip) extends partially into each of the cavities 130, e.g., along the curved recesses.

FIG. 7 is a partial schematic side view of an embodiment of the louvered door 48 taken within line 6-6 of FIG. 5, illustrating the sealing interface 120 with two sealing interface portions 150 and 152 between adjacent louvers 80. As illustrated, each sealing interface portion 150 and 152 includes a seal or gasket 154 disposed in opposite cavities 156 of the adjacent louvers 80. Similar to the embodiment of FIGS. 5 and 6, the gasket 154 and the cavities 156 are disposed between the trailing and leading edges 122 and 124 of adjacent louvers 80. Furthermore, each gasket 154 may have a construction similar to the gasket 132 of FIGS. 5 and 6. In the illustrated embodiment, each cavity 156 is a curved recess (e.g., a semi-circular recess), which extends lengthwise along the louvers 80 generally parallel to the trailing and leading edges 122 and 124. Thus, the gasket 154 (e.g., a round, circular, or cylindrical strip) extends partially into each of the cavities 156, e.g., along the curved recesses. The double seal provided by the two sealing interface portions (e.g., gaskets 154) provides improved sealing and redundancy to ensure that the sealing interface 120 is airtight. In certain embodiments, the sealing interface 120 may include a multi-seal provided by any number of gaskets 154 disposed in adjacent cavities 156, e.g., 2 to 10 or more gaskets 154.

FIG. 8 is a partial schematic side view of an embodiment of the louvered door 48 taken within line 6-6 of FIG. 5, illustrating the sealing interface 120 with three sealing interface portions (e.g., gaskets 170) disposed on a curved interface region 172 between adjacent louvers 80. The curved interface region 172 is defined by a male portion 174 and a female portion 176 between the adjacent louvers 80. In the illustrated embodiment, the male portion 174 protrudes from the trailing edge 122 of one louver 80, while the female portion 176 is recessed into the leading edge 124 of another louver 80. The male and female portions 174 and 176 both have a curved surface, such as a round, oval, or semi-circular surface, which extends lengthwise along the louvers 80 generally parallel to the trailing and leading edges 122 and 124. In certain embodiments, the male and female portions 174 and 176 may have other surface shapes, such as rectangular, triangular, or oval. Regardless of the shape, the male and female portions 174 and 176 may enable a wedge fit, compression fit, or otherwise tighter fit of the gaskets 170 between the adjacent louvers 80. Furthermore, each gasket 170 may be disposed in adjacent recesses on the male and female portions 174 and 176. Again, each gasket 170 may have a construction similar to the gasket 132 of FIGS. 5 and 6. In certain embodiments, the male and female portions 174 and 176 may include any number of gaskets 170, e.g., 1 to 10 or more gaskets 170. The sealing interface 120 of FIG. 8 may substantially improve the seal between the adjacent louvers 80, thereby ensuring an airtight closure of the louvered door 48 in a closed position of the louvers 80.

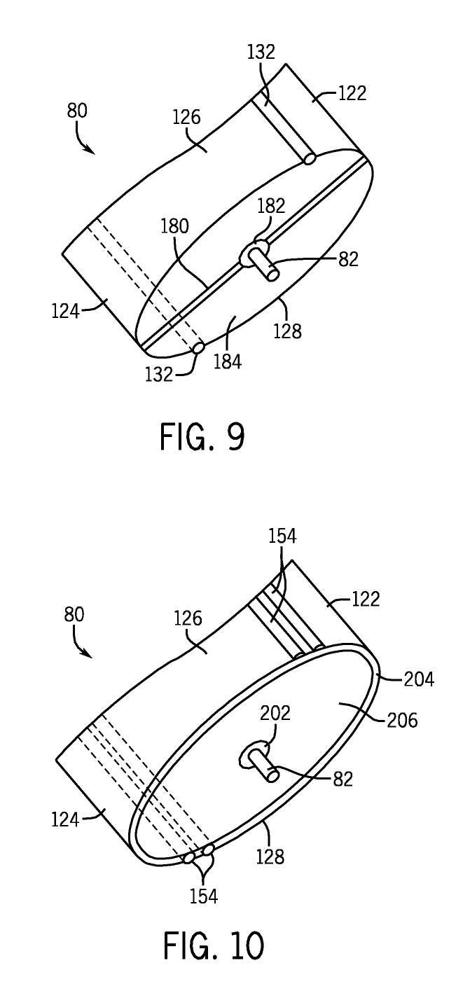

FIG. 9 is a perspective view of an embodiment of a louver 80 with gaskets 180 and 182 on a first end 184. In the illustrated embodiment, the louver 80 includes the gaskets 180 and 182 in combination with the gaskets 132 as illustrated in FIGS. 5 and 6. However, the gaskets 202 and 204 may be used in combination with any of the gaskets illustrated in FIGS. 5-8. The gasket 180 extends along the first end 184 between the trailing and leading edges 122 and 124, while the gasket 182 surrounds the pin 82 (e.g., axis). The gaskets 180 and 182 may have a construction similar to the embodiments of FIGS. 5-8. For example, the gaskets 180 and 182 may include one or more strips of gasket material disposed in corresponding recesses (e.g., curved recesses) along the first end 184. As illustrated, the gasket 180 is a straight strip (or two straight strip portions on opposite sides of the pin 82), while the gasket 182 is a ring-shaped gasket disposed about the pin 82. Together, the gaskets 180 and 182 seal the first end 184 of the louver 80 against the rotational support 87, as illustrated in FIG. 3. A second end of the louver 80 also has the illustrated gaskets 180 and 182, such that opposite ends are completely sealed against the opposite rotational supports 87.

FIG. 10 is a perspective view of an embodiment of a louver 80 with gaskets 202 and 204 on a first end 206. In the illustrated embodiment, the louver 80 includes the gaskets 202 and 204 in combination with the gaskets 154 as illustrated in FIG. 7. However, the gaskets 202 and 204 may be used in combination with any of the gaskets illustrated in FIGS. 5-8. The gasket 202 surrounds the pin 82 (e.g., axis), while the gasket 204 surrounds a perimeter of the first end 206. The gaskets 202 and 204 may have a construction similar to the embodiments of FIGS. 5-8. For example, the gaskets 202 and 204 may include one or more strips of gasket material disposed in corresponding recesses (e.g., curved recesses) along the first end 206. As illustrated, the gasket 202 is a ring-shaped gasket disposed about the pin 82, while the gasket 204 is an oval or closed loop gasket disposed about the perimeter near the trailing and leading edges 122 and 124 and the faces 126 and 128. Together, the gaskets 202 and 204 seal the first end 206 of the louver 80 against the rotational support 87, as illustrated in FIG. 3. A second end of the louver 80 also has the illustrated gaskets 202 and 204, such that opposite ends are completely sealed against the opposite rotational supports 87.

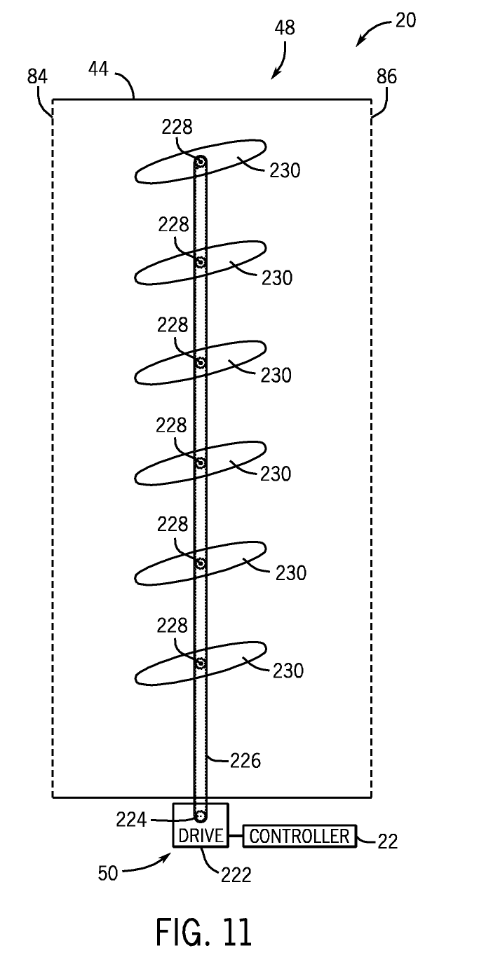

FIG. 11 is a schematic side view of an embodiment of the bypass turbine intake 20 having the louvered door 48 with a plurality of louvers 230 in an open position. The bypass turbine intake 20 includes the drive 50 and the controller 22 to operate the louvered door 48 in response to feedback. In the illustrated embodiment, the drive 50 includes a rotational drive 222 having a gear 224 engaged with a chain 226. The chain 226 also engages with a gear 228 on each louver 230. For example, each gear 228 may be disposed along a central region of the louver 230 to define a rotational axis of the louver 230. During operation of the rotational drive 222, the chain 226 is driven by the gear 224 and causes rotational of the gear 228, thereby driving rotation of each louver 80 between open and closed positions. In contrast to the embodiment of FIGS. 3 and 4, the rotational drive 222 transfers mechanical energy to open and close the louvers 80 directly to the rotational axis (e.g., gear 228), rather than transferring the mechanical energy to a position offset from the rotational axis. In certain embodiments, the louvered door 48 of FIG. 11 may be modified to include a belt and pulley system. For example, the gears 224 and 228 may be replaced with pulleys, and the chain 226 may be replaced with a belt. Furthermore, the louvers 230 of FIG. 11 may have any of the gaskets as described above with reference to FIGS. 5-10.

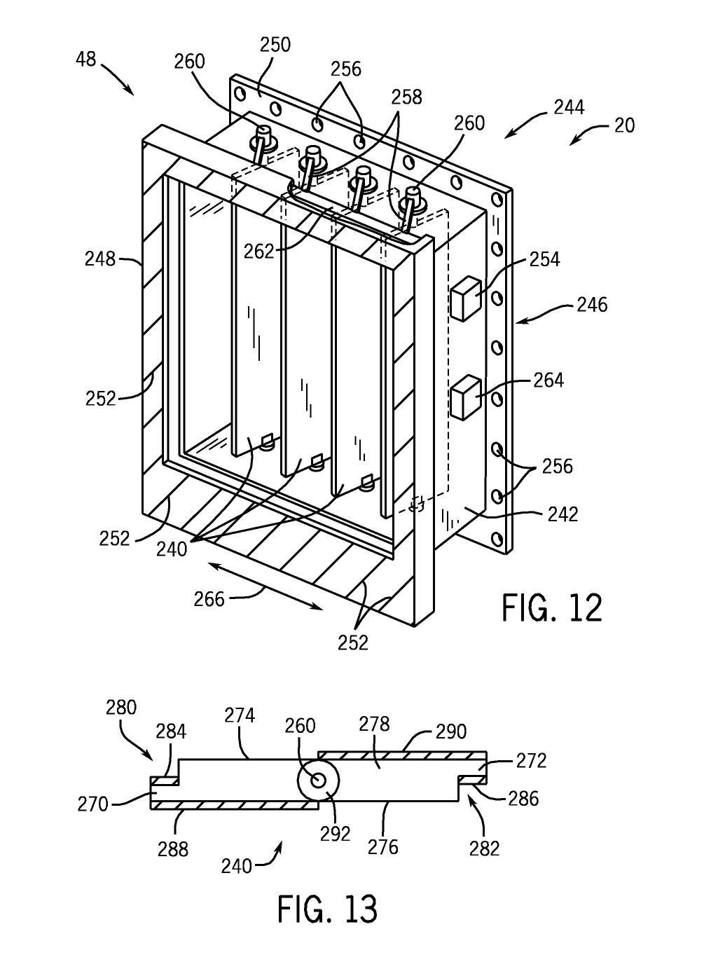

FIG. 12 is a perspective view of an embodiment of the bypass turbine intake 20 having the louvered door 48 with a plurality of louvers 240 in an open position. The louvered door 48 includes a frame 242 supporting the plurality of louvers 240, a louver activation system 244, and an ice melting system 246. The frame 242 includes a front flange or frame portion 248 and a rear flange or frame portion 250. The louver activation system 244 is configured to open and close the louvered door 48 by rotating the louvers 240 forward and rearward between the front and rear flanges 248 and 250. The ice melting system 246 is configured to reduce, eliminate, or prevent ice formation on the louvered door 48, thereby reducing the possibility that ice may interfere with operation of the louvered door 48. In the illustrated embodiment, the ice melting system 246 includes electrical traces 252 coupled to an electrical trace heater 254. The heater 254 is configured to deliver an electric current through the electrical traces 252, thereby generating heat to reduce moisture or ice on the louvered door 48. For example, the electrical traces 252 may be disposed on the front flange 248, the rear flange 250, the louvers 240, or other parts of the intake 20.

The louver activation system 244 is configured to operate the louvered door 48, while the frame 242 is coupled to the housing 44 of the bypass turbine intake 20. For example, the rear flange 250 includes holes 256 to enable bolts to secure the rear flange 250 to the housing 44. The louver activation system 244 includes connection arms 258, pins 260, a linear actuator 262, and a position sensor 264. The louvers 240 attach to the louvered door 48 via pins 260. In particular, the pins 260 pass through holes in the frame 256. The holes in the frame 256 enable rotation of the louvers 240, while blocking all other motion of the louvers 240. The arms 258 connect the linear actuator 262 to the pins 260. As the linear actuator 262 moves along the front flange 248, the arms 258 rotate the pins 260 and thus the louvers 240. For example, if the linear actuator 262 moves in the direction of arrows 266, then the louvers 240 collectively open and close via rotation about the pins 260. The position sensor 264 may be included to determine the position of the louvers 240. In particular, the positioning sensor 264 may signal the linear actuator 262 to continue rotating the louvers 240 or to stop rotation of the louvers 240, depending on their position. For example, if the louvers 240 have not rotated sufficiently to open or close the louvered door 48, then the position sensor 264 signals the linear actuator 262 to continue rotating the louvers 240 until the louvered door 48 is completely open or closed.

FIG. 13 is an end view of an embodiment of a louver 240 of the bypass turbine intake 20 of FIG. 12, illustrating gasket material on opposite sides of the louver 240. The louver 240 includes a leading edge 270, a trailing edge 272, a top surface 274, a bottom surface 276, a first end 278, and a second end opposite from the first end. The leading and trailing edges 270 and 272 include notches 280 and 282 with gaskets 284 and 286, respectively. The notches 280 and 282 with the gaskets 284 and 286 enable adjacent louvers 240 to interlock with one another (e.g., notches 280 and 282) and seal with one another (e.g., gaskets 284 and 286), thereby providing an airtight seal between the adjacent louvers 240. Furthermore, the louver 240 includes end gaskets 288, 290, and 292 disposed along the first end 278 and the second end, thereby providing an airtight seal between the louvers 240 and the surrounding frame 242. For example, the end gaskets 288 and 290 extend along the first end 278 between the leading and trailing edges 270 and 272, while the gasket 292 surrounds the pin 260. Furthermore, the gaskets 288, 290, and 292 of FIGS. 12 and 13 may have any of the gaskets as described above with reference to FIGS. 5-10.

Technical effects of the disclosed embodiments include the ability to provide bypass air to a gas turbine through a secondary air intake, which includes a louvered door for improved performance and reduced space consumption. The louvered door is configured to provide an airtight seal while in a closed position. Thus, the louvered door includes various seals or gaskets between adjacent louvers, support structures, and movable parts.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a bypass turbine intake configured to route a bypass supply of air to a turbine engine to bypass an air filter of a main turbine intake, wherein the bypass turbine intake comprises a louvered door having a plurality of louvers configured to move between a closed position and an open position, the open position enables flow of the bypass supply of air to the turbine engine, and the closed position disables flow of the bypass supply of air to the turbine engine.

2. The system of claim 1, wherein the louvered door comprises a sealing system configured to seal the plurality of louvers relative to one another in the closed position.

3. The system of claim 2, wherein each louver of the plurality of louvers comprises a first seal portion disposed along a leading edge portion of the louver, a second seal portion disposed along a trailing edge portion of the louver, a third seal portion disposed along a first end portion of the louver, and a fourth seal portion disposed along a second end portion of the louver.

4. The system of claim 1, wherein the louvered door comprises a drive coupled to a louver actuator, and the louvered actuator is configured to move the plurality of louvers between the closed position and the open position in response to the drive.

5. The system of claim 4, comprising a controller coupled to the drive, wherein the controller is configured to control the drive to move the plurality of louvers from the closed position to the open position in response to a condition of the main turbine intake.

6. The system of claim 5, comprising at least one sensor configured to indicate the condition of the main turbine intake, wherein the condition comprises a change in a main supply of air through the main turbine intake outside a threshold range.

7. The system of claim 1, comprising the main turbine intake having the air filter, wherein the main turbine intake is configured to route a main supply of air to the turbine engine.

8. The system of claim 1, comprising the turbine engine.

9. The system of claim 8, comprising a propulsion system coupled to the turbine engine.

10. The system of claim 9, comprising a watercraft having the turbine engine, the propulsion system, the main turbine intake, and the bypass turbine intake.

11. A system, comprising:
a bypass engine intake configured to route a bypass supply of air to an engine to bypass an air filter of a main engine intake, wherein the bypass engine intake comprises:
a louvered door having a plurality of louvers;
a drive having a louver actuator; and
a controller configured to control the drive to move the plurality of louvers between a closed position and an open position in response to a condition of the main engine intake, the open position enables flow of the bypass supply of air to the engine, the closed position disables flow of the bypass supply of air to the engine, and the condition comprises a change in a main supply of air through the main air intake outside a threshold range.

12. The system of claim 11, wherein the louvered door comprises a sealing system configured to seal the plurality of louvers relative to one another in the closed position.

13. The system of claim 11, wherein the bypass engine intake comprises a first screen disposed upstream of the louvered door or a second screen disposed downstream from the louvered door.

14. The system of claim 11, comprising at least one sensor configured to indicate the condition of the main engine intake, wherein the sensor comprises a flow sensor or a pressure sensor.

15. The system of claim 11, comprising the main engine intake having the air filter, wherein the main engine intake is configured to route a main supply of air to the engine.

16. The system of claim 11, comprising the engine.

17. The system of claim 16, comprising a propulsion system coupled to the engine.

18. A system, comprising:
a bypass engine intake configured to route a bypass supply of air to an engine to bypass an air filter of a main engine intake, wherein the bypass engine intake comprises:
a louvered door having a plurality of louvers;
a drive having a louver actuator;
a sensor configured to indicate the condition of the main turbine intake; and
a controller configured to control the drive to move the plurality of louvers between a closed position and an open position in response to an indication of the condition of the main engine intake from the sensor, the open position enables flow of the bypass supply of air to the engine, the closed position disables flow of the bypass supply of air to the engine, and the condition comprises a change in a main supply of air through the main air intake outside a threshold range.

19. The method of claim 18, wherein the sensor senses a pressure differential across the air filter in the main engine intake.

20. The method of claim 18, wherein the sensor senses a flow rate below a threshold flow rate.
